(19) United States
(12) Patent Application Publication
(10) Pub. No.: US 2011/0298683 A1
(43) Pub. Date: Dec. 8, 2011

(54) CHIP ANTENNA AND ANTENNA DEVICE

(75) Inventors: Hiroya TANAKA, Kyoto-fu (JP); Ryo KOMURA, Kyoto-fu (JP); Kazuhisa YAMAKI, Kyoto-fu (JP); Yuichi KUSHIHI, Kyoto-fu (JP)

(73) Assignee: MURATA MANUFACTURING CO., LTD., Kyoto-fu (JP)

(21) Appl. No.: 13/213,940

(22) Filed: Aug. 19, 2011

Related U.S. Application Data
(63) Continuation of application No. PCT/JP2009/066338, filed on Sep. 18, 2009.

(30) Foreign Application Priority Data
Feb. 20, 2009 (JP) 2009-038436

(51) Int. Cl. H01Q 1/52

(52) U.S. Cl. 343/841

(57) ABSTRACT

This disclosure provides a chip antenna and an antenna device including the chip antenna. The chip antenna is not likely to be affected by a ground electrode located lower than the chip antenna when the chip antenna is mounted on a circuit board, and can have resulting small frequency variation and small reduction in gain. The chip antenna includes a dielectric substrate having a bottom face, a top face, a first side face, a second side face, a third side face, and a fourth side face. A non-feeding electrode extends from the fourth side face to the top face, another non-feeding electrode extends from the third side face to the top face. An end of the non-feeding electrode and an end of the non-feeding electrode face each other on the top face with a certain space therebetween. The bottom face includes bottom-face electrodes electrically connected to the non-feeding electrodes and a bottom-face electrode electrically connected to a feeding electrode.

### CROSS REFERENCE TO RELATED APPLICATIONS

The present application is a continuation of International Application No. PCT/JP2009/066338 filed Sep. 18, 2009, which claims priority to Japanese Patent Application No. 2009-038436 filed Feb. 20, 2009, the entire contents of each of these applications being incorporated herein by reference in their entirety.

### TECHNICAL FIELD

The invention relates to a chip antenna and an antenna device including the chip antenna, and in particular, to a chip antenna in which various electrodes are formed on outer faces of a dielectric substrate having a rectangular parallelepiped shape and an antenna device including the chip antenna.

### BACKGROUND

A chip antenna in which a feeding electrode and a non-feeding electrode facing each other with a certain space therebetween are formed on a dielectric substrate is described in Japanese Unexamined Patent Application Publication No. 2004-7345 (PTL 1). FIG. 1A includes six side views of the chip antenna described in PTL 1, and FIG. 1B is an equivalent circuit diagram of the chip antenna.

As illustrated in FIG. 1A, a feeding electrode 34 is formed on a dielectric substrate 31 having a rectangular parallelepiped shape so as to extend from the bottom face via the fourth side face to the top face. Similarly, a non-feeding electrode 36 is formed so as to extend from the bottom face via the third side face to the top face. The feeding electrode 34 and the non-feeding electrode 36 are formed to face each other with a certain space therebetween on the top face of the dielectric substrate 31.

As illustrated in FIG. 1B, the feeding electrode 34 and the non-feeding electrode 36 are coupled to each other when open ends of the feeding electrode 34 and the non-feeding electrode 36 face each other with a certain space therebetween. Accordingly, wide band characteristics can be attained.

### SUMMARY

The present disclosure provides a chip antenna that is not likely to be affected by a ground electrode located lower than the chip antenna in a state where the chip antenna is mounted on a circuit board, which can result in a small frequency variation and small reduction in the antenna gain. The present disclosure also provides an antenna device including the chip antenna.

In an embodiment, a chip antenna includes a dielectric substrate having a rectangular parallelepiped shape. The dielectric substrate includes a bottom face, a top face, a first side face, a second side face, a third side face, and a fourth side face. The first side face and the second side face face each other, and the third side face and the fourth side face each other. The first side face and the second side face include no electrode. The dielectric substrate includes a first non-feeding electrode extending from the fourth side face to the top face, and a second non-feeding electrode that faces the non-feeding electrode with a certain space therebetween and extends from the third side face to the top face. The bottom face includes bottom-face electrodes for the first and second non-feeding electrodes. The bottom-face electrodes are electrically connected to respective non-feeding lines of a circuit board on which the chip antenna is mounted. The dielectric substrate includes a feeding electrode, where the feeding electrode forms a capacitance between the feeding electrode and one of the first and second non-feeding electrodes. The bottom face includes a bottom-face electrode for the feeding electrode, which is electrically connected to the feeding electrode and electrically connected to a feeding line of the circuit board on which the chip antenna is mounted.

In a more specific embodiment, an antenna device includes the chip antenna as described above and a circuit board on which the chip antenna is mounted. The antenna device includes a frequency-regulating element arranged on the circuit board. The frequency-regulating element is connected between a ground electrode on the circuit board and one, some, or all of the feeding line and the non-feeding lines.

In another more specific embodiment, antenna device includes the chip antenna as described above and a circuit board on which the chip antenna is mounted. The antenna device includes an impedance element arranged on the circuit board and connected between the feeding line and a ground electrode on the circuit board.

In yet another more specific embodiment, antenna device includes the chip antenna as described above, and a circuit board on which the chip antenna is mounted. The chip antenna is mounted in a non-ground area of the circuit board.

### BRIEF DESCRIPTION OF DRAWINGS

FIG. 1A includes six side views of a chip antenna described in PTL 1, and FIG. 1B is an equivalent circuit diagram of the chip antenna.

FIG. 2A includes six side views of a chip antenna 101 according to a first exemplary embodiment, FIG. 2B is a perspective view of an antenna device 201 including the chip antenna 101, and FIG. 2C is an equivalent circuit diagram of the antenna device 201.

FIG. 3 is a perspective view of an antenna device 202 according to a second exemplary embodiment.

### DETAILED DESCRIPTION

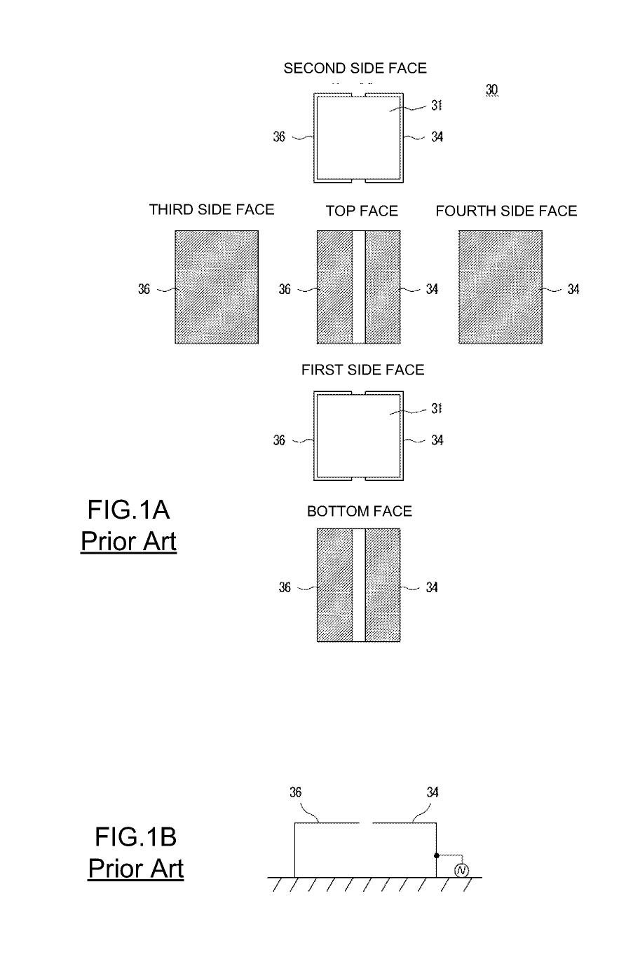

In the known chip antenna illustrated in FIG. 1A, a chip antenna 30 is mounted in a non-ground area on a circuit board. The resonant frequency of the antenna greatly depends on the positional relationship with a ground electrode on the circuit board. In particular, the inventors realized that there is a problem in that when a ground electrode is located lower and near a chip antenna, the frequency characteristics vary or the gain is reduced because of the effect of the ground electrode.

The present disclosure provides a chip antenna that is not likely to be affected by a ground electrode located lower than the chip antenna in a state where the chip antenna is mounted on a circuit board, that causes only a small frequency variation, and that causes only a small reduction in the antenna gain, and an antenna device including the chip antenna.

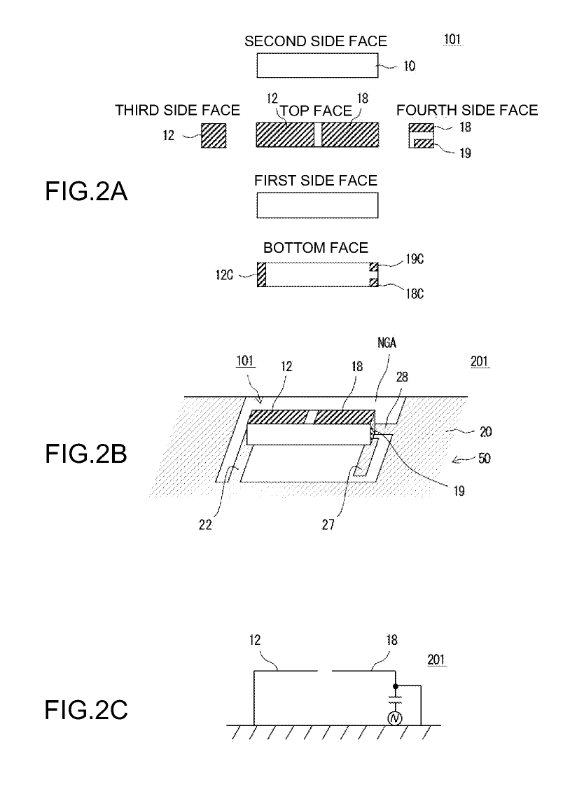

FIG. 2A includes six side views of a chip antenna 101 according to a first exemplary embodiment, FIG. 2B is a perspective view of a principal portion of an antenna device 201 including the chip antenna 101, and FIG. 2C is an equivalent circuit diagram of the antenna device 201.

A dielectric substrate 10 having a rectangular parallelepiped shape has a bottom face (a face to be in contact with a circuit board when the chip antenna is mounted on the circuit board), a top face, first and second side faces that face each other, and third and fourth side faces that face each other. A non-feeding electrode 18 is formed on the dielectric substrate 10 so as to extend from the fourth side face to the top face. A non-feeding electrode 12 is formed on the dielectric substrate 10 so as to extend from the third side face to the top face. Ends (open ends) of the non-feeding electrode 18 and the non-feeding electrode 12 face each other with a certain space therebetween on the top face of the dielectric substrate 10.

A feeding electrode 19 that is adjacent to the non-feeding electrode 18 is formed on the fourth side face of the dielectric substrate 10.

Bottom-face electrodes 12C and 18C for non-feeding are electrically connected to the non-feeding electrodes 12 and 18, respectively, and are formed on the bottom face of the dielectric substrate 10. A bottom-face electrode 19C for a feeding electrode is electrically connected to the feeding electrode 19 and is formed on the bottom face of the dielectric substrate 10.

As illustrated in FIG. 2B, a ground electrode 20 is formed on the top face of a circuit board 50, and a non-ground area (NGA) is arranged on the top face of the circuit board 50. The chip antenna 101 is mounted in the non-ground area NGA, as illustrated in the drawing. A feeding line 27 and non-feeding lines 22 and 28 are also formed in the non-ground area NGA. When the chip antenna 101 is in a mounted state, the bottom-face electrode 19C for a feeding electrode is electrically connected to the feeding line 27. In addition, the bottom-face electrodes 12C and 18C for non-feeding electrodes are electrically connected to the non-feeding lines 22 and 28, respectively. A feeding circuit, which is not illustrated in FIG. 2B, is connected between the feeding line 27 and the ground electrode 20.

The equivalent circuit of the antenna device 201 is as illustrated in FIG. 2C. As is clear from this, since a capacitance used for capacitive feeding to the non-feeding electrode 18 is generated between the non-feeding electrode 18 and the feeding electrode 19, the resonant frequency can be reduced compared to a configuration in which direct feeding is carried out by a feeding electrode. Therefore, the sizes of the chip antenna and the antenna device can be reduced.

In addition, by connecting the non-feeding electrodes 12 and 18 to the ground electrode 20 (to the ground), a current is made to flow to the boundary between the ground electrode 20 and the non-ground area NGA. Thus, the boundary between the ground electrode 20 and the non-ground area NGA serves as a current path of the antenna. As a result, the current path of the antenna is visibly longer (the equivalent length increases), the frequency is reduced, and the size of the antenna can be reduced. Furthermore, due to the current path, the antenna is visibly larger (the equivalent volume of the antenna increases), thus increasing the antenna gain.

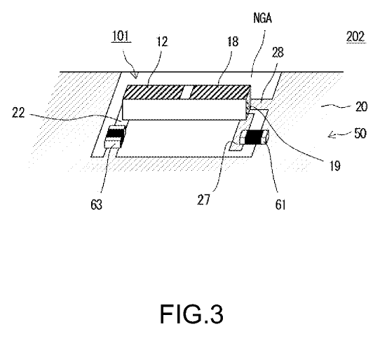

FIG. 3 is a perspective view of an antenna device 202 according to a second exemplary embodiment.

A ground electrode 20 is formed on the top face of a circuit board 50, and a non-ground area NGA is arranged on the top face of the circuit board 50. A chip antenna 101 is mounted in the non-ground area NGA, as illustrated in the drawing. The chip antenna 101 is the same as the chip antenna 101 described in the first exemplary embodiment. A feeding line 27 and non-feeding lines 22 and 28 are formed in the non-ground area NGA of the circuit board 50.

When the chip antenna 101 is in a mounted state, a bottom-face electrode 18C for a feeding electrode is electrically connected to the feeding line 27. Bottom-face electrodes 12C and 18C for non-feeding electrodes are electrically connected to non-feeding lines 22 and 28, respectively. A feeding circuit, which is not illustrated in FIG. 3, is connected between the feeding line 27 and the ground electrode 20.

In this example, a frequency-regulating element 63 is connected in series to the non-feeding line 22. An impedance element 61 is connected in parallel between the feeding line 27 and the ground electrode 20.

The antenna device 202 is implemented by mounting the frequency-regulating element 63, the impedance element 61, and the chip antenna 101 on the circuit board 50, as described above. The frequency-regulating element 63 and the impedance element 61 are, for example, a chip capacitor and a chip inductor. With such impedances, setting of the resonant frequency and the impedance of the antenna can be achieved. For example, when an inductive element is used as the frequency-regulating element 63 connected in series to a base portion of the non-feeding electrode 12, the resonant frequency of the antenna can be reduced. In addition, with the use of the impedance element 61 connected between the feeding line 27 and the ground electrode 20, impedance matching between the feeding circuit and the antenna device 202 can be achieved.

With embodiments according to the disclosure, a current is made to flow to the boundary between the ground electrode and a non-ground area by connecting a non-feeding electrode to a ground electrode (to the ground). Thus, the boundary between the ground electrode and the non-ground area serves as a current path of the antenna. As a result, the current path of the antenna is visibly longer (the equivalent length increases), the frequency is reduced, and the size of the antenna can be reduced. Furthermore, due to the current path, the antenna is visibly larger (the equivalent volume of the antenna increases), thus increasing the antenna gain. In addition, since a capacitance is generated between a non-feeding electrode to which capacitive feeding is performed and a feeding electrode, the resonant frequency can be reduced compared to a configuration in which direct feeding is carried out by a feeding electrode. Therefore, reductions in the sizes of the chip antenna and the antenna device can be achieved.

While exemplary embodiments have been described above, it is to be understood that variations and modifications will be apparent to those skilled in the art without departing from the scope and spirit of the disclosure.

What is claimed is:

1. A chip antenna comprising:
a dielectric substrate having a rectangular parallelepiped shape and having a bottom face, a top face, a first side face, a second side face, a third side face, and a fourth side face, the first side face and the second side face facing each other, the third side face and the fourth side face facing each other, wherein:
the first side face and the second side face include no electrode,
the dielectric substrate includes a first non-feeding electrode so as to extend from the fourth side face to the top face,
the dielectric substrate includes a second non-feeding electrode that faces the first non-feeding electrode with a certain space therebetween so as to extend from the third side face to the top face,
the bottom face includes bottom-face electrodes for the first and second non-feeding electrodes, the bottom-face electrodes electrically connected to the respective first and second non-feeding electrodes and electrically connected to respective non-feeding lines of a circuit board on which the chip antenna is mounted,
the dielectric substrate includes a feeding electrode, the feeding electrode forming a capacitance between the feeding electrode and one of the first and second non-feeding electrodes, and
the bottom face of the dielectric substrate includes a bottom-face electrode for the feeding electrode, the bottom-face electrode electrically connected to the feeding electrode and to a feeding line of the circuit board on which the chip antenna is mounted.

2. An antenna device comprising the chip antenna according to claim 1 and a circuit board on which the chip antenna is mounted,
wherein a frequency-regulating element is arranged on the circuit board, the frequency-regulating element being connected between a ground electrode on the circuit board and one, some, or all of the feeding line and the non-feeding lines.

3. An antenna device comprising the chip antenna according to claim 1 and a circuit board on which the chip antenna is mounted,
wherein an impedance element is arranged on the circuit board, the impedance element being connected between the feeding line and a ground electrode on the circuit board.

4. An antenna device comprising the chip antenna according to claim 1 and a circuit board on which the chip antenna is mounted,
wherein the chip antenna is mounted in a non-ground area of the circuit board.
